(19) United States
(12) Patent Application Publication
(10) Pub. No.: US 2024/0224841 A1
(43) Pub. Date: Jul. 11, 2024

(54) FERTILIZATION ASSISTANCE APPARATUS, FERTILIZATION ASSISTANCE METHOD, AND STORAGE MEDIUM

(71) Applicant: NEC Corporation, tokyo (JP)

(72) Inventors: Mako YAMADA, Tokyo (JP); Shu Watanabe, Tokyo (JP); Yusuke Kikuchi, Tokyo (JP)

(73) Assignee: NEC Corporation, Tokyo (JP)

(21) Appl. No.: 18/397,125

(22) Filed: Dec. 27, 2023

(30) Foreign Application Priority Data
Jan. 5, 2023 (JP) 2023-000488

(51) Int. Cl. A01C 21/00; G06Q 50/02

(52) U.S. Cl. CPC A01C 21/007; G06Q 50/02

(57) ABSTRACT

A fertilization assistance apparatus estimates estimation soil nitrogen distribution in a farm field by analyzing color of soil of the farm field in a captured image in which the farm field before planting is imaged. The fertilization assistance apparatus determines whether there is a correlation between the color of soil and growth situation of a crop in the farm field. In a case where there is a correlation between the color of soil and the growth situation of the crop in the farm field, the fertilization assistance apparatus generates basal fertilizer variable fertilization information using the information about the estimation soil nitrogen distribution. The basal fertilizer variable fertilization information indicates a relationship between the position in the farm field and the amount of applied fertilizer at the position in a case where the variable fertilization of basal fertilizer is performed.

This application is based upon and claims the benefit of priority from Japanese Patent Application No. 2023-000488, filed on Jan. 5, 2023, the disclosure of which is incorporated herein in its entirety by reference.

### TECHNICAL FIELD

The present disclosure is a technique related to fertilization of applying fertilizer to crops.

### BACKGROUND ART

Fertilizer to be applied to crops are roughly classified into basal fertilizer and additional fertilizer. Basal fertilizer is a fertilizer applied to soil before planting a crop. Additional fertilizer is a fertilizer given to add nutrients during the growth of crops. Variable fertilization is one of the methods of applying fertilizer to soil and crops. The variable fertilization is a method of fertilization in which the amount of applied fertilizer per unit area (hereinafter, it may be simply referred to as the amount of applied fertilizer) in the farm field is not made the same throughout the farm field but is varied depending on the place. Reference Document 1 (JP 2011-254711 A) discloses a technique for variable fertilization of basal fertilizer. Reference Document 2 (JP 2021-114271 A) discloses a technique for calculating a spraying amount of a spraying agent in a case where the spraying agent is sprayed to a farm field using an agricultural drone.

### SUMMARY

A main object of the present disclosure is to provide useful information for suppressing variations in the growth situation of crops in a farm field.

In an aspect of a fertilization assistance apparatus according to the present disclosure, the fertilization assistance apparatus includes a memory configured to store instructions, and a processor configured to execute the instructions to estimate a distribution of an amount of soil nitrogen in a farm field as an estimation soil nitrogen distribution by analyzing a color of soil in the farm field in a captured image in which the farm field before planting is imaged; generate basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and output the basal fertilizer variable fertilization information.

In an aspect of a fertilization assistance method according to the present disclosure, the method includes estimating a distribution of an amount of soil nitrogen in a farm field as an estimation soil nitrogen distribution by analyzing a color of soil in the farm field in a captured image in which the farm field before planting is imaged; generating basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and outputting the basal fertilizer variable fertilization information.

In an aspect of a non-transitory computer readable storage medium that stores a computer program according to the present disclosure, the computer program causes a computer to execute the steps of estimating a distribution of an amount of soil nitrogen in a farm field as an estimation soil nitrogen distribution by analyzing a color of soil in the farm field in a captured image in which the farm field before planting is imaged; generating basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and outputting the basal fertilizer variable fertilization information.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration of an example embodiment of a fertilization assistance apparatus according to the present disclosure;

FIG. 2 is a diagram illustrating an example of a result of determining the color of soil of the farm field from the captured image;

FIG. 3 is a diagram illustrating an example of a display mode of basal fertilizer variable fertilization information;

FIG. 4 is a flowchart for explaining an example of an operation in an example embodiment of the fertilization assistance apparatus;

FIG. 5 is a diagram illustrating a configuration of another example embodiment of the fertilization assistance apparatus according to the present disclosure;

FIG. 6 is a diagram illustrating a configuration of another example embodiment of the fertilization assistance apparatus according to the present disclosure; and

FIG. 7 is a flowchart illustrating an example of an operation in another example embodiment of the fertilization assistance apparatus of another example embodiment.

### EXAMPLE EMBODIMENT

Before describing an example embodiment according to the present disclosure, an example of a technique related to fertilization of applying fertilizer to crops in a farm field will be described. For example, in the technique disclosed in Reference Document 1 (JP 2011-254711 A), first, remote sensing data and soil sampling data are acquired, and a fertilization map in a farm field is generated using the acquired data. The remote sensing data is data acquired from a captured image of the farm field by a helicopter or the like, and is data representing the distribution of the color of soil of the farm field. The soil sampling data is data of an analysis result obtained by analyzing hot water extracted nitrogen of soil sampled from several places in the farm field. In JP 2011-254711 A, the fertilization map is data in which the farm field is divided into mesh shapes, and the amount of applied fertilizer is indicated for each mesh unit.

The amount of applied fertilizer in each mesh unit of the farm field is calculated in such a way that the amount of nitrogen in the soil is the same throughout the farm field using remote sensing data, soil sampling data, and standard amount of applied fertilizer data given in advance. Nitrogen, phosphorus and potassium are referred to as three elements of fertilizer. Nitrogen is a component that mainly increases the effect on leaf growth. Phosphoric acid is a component that mainly increases the effect on flowers and fruits. Potassium is a component that increases the effect on root growth. Among the three elements of the fertilizer, nitrogen is the component most greatly involved in the growth and yield of the crop. The blending ratio of nitrogen, phosphorus, and potassium in the fertilizer is determined in advance according to the land to be fertilized, the application of the fertilizer, and the like. That is, in JP 2011-254711 A, the required amount of applied fertilizer of nitrogen is calculated for each mesh unit of the farm field, and the amount of applied fertilizer is calculated using the calculated amount of applied fertilizer of nitrogen and a predetermined blending ratio of fertilizer elements.

Based on the fertilization map generated as described above and the position information about the automatic variable fertilization machine, the variable fertilization is performed by controlling the amount (amount of applied fertilizer) of fertilizer (basal fertilizer) discharged by the automatic variable fertilization machine in the farm field.

In such variable fertilization of basal fertilizer, nitrogen, which is the most important for the growth of crops, is evenly contained in the entire farm field at the time of planting, thereby suppressing variations in the growth of crops to be planted in the farm field.

However, since the variable fertilization of basal fertilizer is performed in the farm field using the fertilization map based on the amount of soil nitrogen as described above, a crop producer or a farm field administrator (hereinafter, the crop producer and the farm field administrator are collectively referred to as farm field interested party) may suspect that the variations in the growth situation of the crop in the farm field is larger than that in the case where the variable fertilization is not performed.

Therefore, in the example embodiment described below, a technique for providing useful information for suppressing variations in the growth situation of crops in a farm field is proposed.

### First Example Embodiment

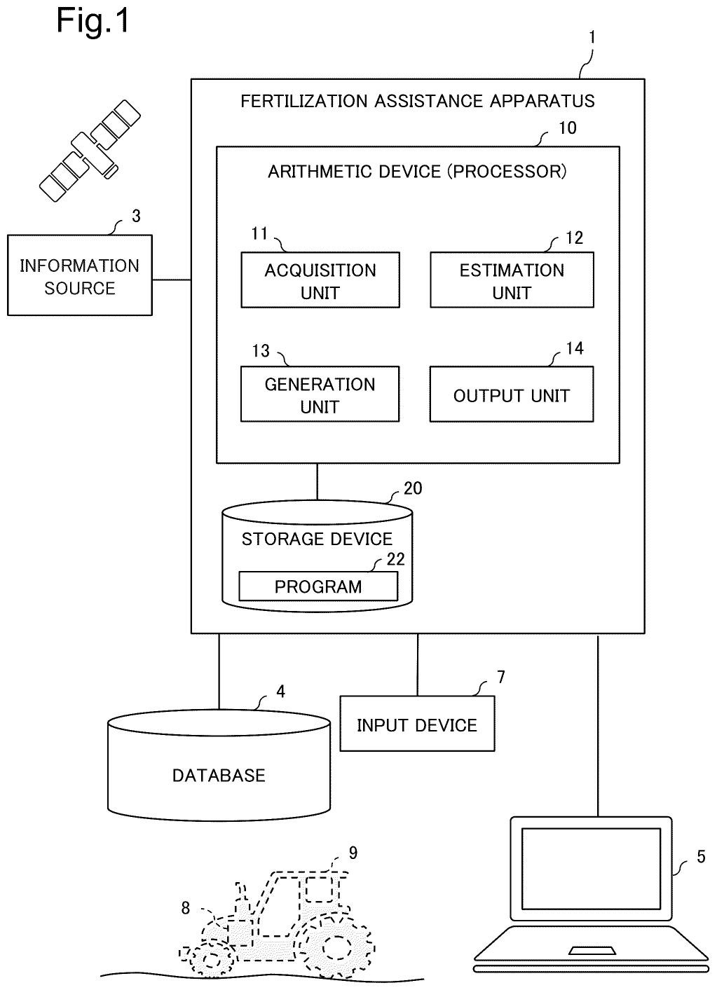

A fertilization assistance apparatus 1 according to the first example embodiment of the present disclosure is an apparatus that has a configuration as illustrated in FIG. 1 to output information for assisting in variable fertilization of basal fertilizer and variable fertilization of additional fertilizer in a farm field. The fertilization assistance apparatus 1 is connected to an information source 3, a database 4, a terminal device 5, and an input device 7.

The information source 3 is an information source that outputs information used by the fertilization assistance apparatus 1. The number of information sources 3 to which the fertilization assistance apparatus 1 is connected is not limited to one, and the fertilization assistance apparatus 1 is connected to a plurality of information sources 3 as necessary. In the first example embodiment, one of the information sources 3 is an information source that outputs a satellite image of the farm field to be assisted. The satellite image of the farm field is a captured image in which the farm field is imaged by an imaging device mounted on an artificial satellite. Another one of the information sources 3 is an information source that outputs weather information about a region including the farm field to be assisted.

The input device 7 is a device from which an operator of the device inputs information to the fertilization assistance apparatus 1, and includes a keyboard, a mouse, and the like. The database 4 is a storage device, and the database 4 stores information acquired from the information source 3, information input by the input device 7, data calculated by the fertilization assistance apparatus 1, and the like.

The terminal device 5 is a computer device operated by a user who is a farm field interested party (a farm field administrator, a crop producer, or the like). The terminal device 5 has a communication function and a display control function of causing a display device to display information. As long as the terminal device 5 is an information device having a communication function and a display control function, its type is not limited, and specific examples thereof include a personal computer, a tablet, and a smartphone. In a case where the terminal device 5 is a smartphone or a tablet, the display device is integrated with the terminal device 5. However, in a case where the terminal device 5 is a personal computer, the display device may be externally attached. The connection between the terminal device 5 and the fertilization assistance apparatus 1 is executed by an application program (application) for causing the terminal device 5 to have a function of cooperating with the fertilization assistance apparatus 1. Alternatively, the connection between the terminal device 5 and the fertilization assistance apparatus 1 may be executed by a browser (software for browsing information about the Internet). Whether the connection between the terminal device 5 and the fertilization assistance apparatus 1 is executed by the application or the browser is appropriately set by a system designer or the like, and is not limited.

The fertilization assistance apparatus 1 is indirectly or directly connected to a variable fertilization control device 8. The variable fertilization control device 8 is mounted on an agricultural machine 9 that performs fertilization in a farm field, and has a function of controlling an amount of applied fertilizer applied from the agricultural machine 9 to the farm field.

The fertilization assistance apparatus 1 is a computer device, and includes an arithmetic device 10 and a storage device 20. The storage device 20 includes a storage medium that stores data and a computer program (hereinafter, also referred to as a program) 22. There is a plurality of types of storage devices, and the computer device may include a plurality of types of storage devices. The type and the number of storage devices provided in the fertilization assistance apparatus 1 are not limited, and the description thereof will be omitted.

The arithmetic device 10 includes a processor such as a central processing unit (CPU) and a graphics processing unit (GPU), and can have various functions based on the program 22 by reading and executing the program 22 stored in the storage device 20. The arithmetic device 10 includes an acquisition unit 11, an estimation unit 12, a generation unit 13, and an output unit 14 as functional units that provide information for assisting in fertilization.

The acquisition unit 11 acquires information from the information source 3 at a predetermined timing. In the first example embodiment, the information acquired by the acquisition unit 11 from one of the information sources 3 is a satellite image of the farm field, and the acquisition timing is a predetermined fertilization information acquisition period before at least variable fertilization of each of basal fertilizer and additional fertilizer is performed. The satellite image of the farm field acquired by the acquisition unit 11 is a plurality of satellite images of the farm field to be assisted that is imaged within the fertilization information acquisition period related to each of the basal fertilizer and the additional fertilizer and whose imaging time points are different. The farm field imaged within the fertilization information acquisition period related to basal fertilizer is a farm field before planting, and the soil of the farm field to be assisted is imaged in the satellite image of the farm field. In the satellite image of the farm field within the fertilization information acquisition period related to additional fertilizer, crops planted in the farm field are imaged. The satellite image of the farm field acquired by the acquisition unit 11 is stored in the database 4 or the storage device 20 in association with, for example, farm field weather information indicating weather of the farm field to be assisted at the imaging time point acquired from another information source 3, imaging date and time information, and the like.

The estimation unit 12 analyzes the color of soil of the farm field before planting using the satellite image of the farm field captured within the fertilization information acquisition period related to basal fertilizer. That is, the estimation unit 12 analyzes the reflectance in the visible red region of the farm field from the satellite image. There is a correspondence relationship between the reflectance in the visible red region and the color (soil color) of the soil that the color (soil color) of the soil is lighter as the reflectance in the visible red region is higher. In other words, there is a correspondence relationship between the reflectance in the visible red region and the color (soil color) of the soil that the color (soil color) of the soil is darker as the reflectance in the visible red region is lower. After analyzing the color of soil, the estimation unit 12 calculates (estimates) the distribution of the amount of soil nitrogen in the farm field to be assisted as the estimation soil nitrogen distribution. That is, the estimation unit 12 calculates the estimation soil nitrogen distribution as follows. For example, data of hot water extracted nitrogen by analysis of soil sampled from at least two places in the farm field to be assisted is acquired in advance. The hot water extracted nitrogen data of the soil is stored in the storage device 20 and the database 40 in association with sampling position information indicating a place where the soil was sampled. The soil of the sampling is preferably soil having a large difference in the color of soil, and includes, for example, soil with a portion where the color of soil is the darkest and soil with a portion where the color of soil is the lightest in the farm field.

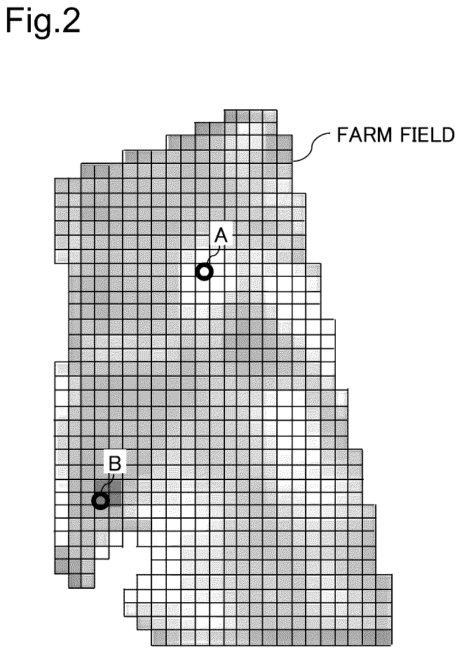

In the first example embodiment, a plurality of division regions obtained by dividing a farm field into a plurality of regions is set in the farm field. The estimation unit 12 determines the color of soil for each division region of the farm field from the satellite image of the farm field captured within the fertilization information acquisition period related to basal fertilizer. FIG. 2 is a diagram schematically illustrating a determination result by the estimation unit 12. In the example of FIG. 2, the farm field is divided in a mesh shape, and the determination result regarding the color of soil of each of the division regions is represented by the shade of color. In FIG. 2, the determination result of the color of soil is illustrated in such a way that the color in the division region of the farm field is darker as the color of the determined soil is darker. Such a determination result of the color of soil is stored in the storage device 20 and the database 4 in association with, as the distribution information about the color of soil, information about the imaging date and time of the captured image for which the determination has been made, weather information about the farm field at the imaging time point, and the like. As the satellite image of the farm field of which the estimation unit 12 determines the color of soil, for example, a satellite image selected from a plurality of satellite images captured within the same fertilization information acquisition period acquired by the acquisition unit 11 in consideration of, for example, easiness of determining the color of soil is used. That is, the state of the soil appearing in the satellite image changes depending on the weather condition of the region including the farm field, soil moisture level, and the like, and the satellite image of any farm field is not necessarily an image of the soil preferable for determining the color of soil. Therefore, a satellite image preferable for determination of the color of soil of the farm field is selected from a plurality of satellite images of the farm field having different imaging dates within the fertilization information acquisition period, and the estimation unit 12 determines the color of soil of the farm field to be assisted using the selected satellite image.

The estimation unit 12 estimates (calculates) the amount of soil nitrogen of each of the division regions of the farm field using the determination result regarding the color of soil of the farm field and the data of hot water extracted nitrogen of the farm field acquired in advance. For example, it is assumed that data of hot water extracted nitrogen of the soil of the division region A (the lightest region) and data of hot water extracted nitrogen of the soil of the division region B (the darkest region) in the farm field illustrated in FIG. 2 are acquired. It is known that there is a correlation between the color of soil and the amount of nitrogen contained in the soil (amount of soil nitrogen) that the amount of soil nitrogen increases as the color of soil is darker (see, for example, JP 2011-254711 A). The estimation unit 12 estimates the hot water extracted nitrogen of each of the division regions of the farm field using the data of the hot water extracted nitrogen of each of the division regions A and B of the farm field, the determination result of the color of soil, and the correlation between the color of soil and the amount of soil nitrogen. That is, the estimation unit 12 calculates the distribution of the amount of soil nitrogen (estimation soil nitrogen distribution) in the farm field to be assisted. The information about the estimation soil nitrogen distribution is stored in the storage device 20 and the database 4 in association with the distribution information about the soil color used for calculating the information, the information about the imaging date and time of the captured image, the weather information about the farm field at the imaging time point, and the like.

In the first example embodiment, the estimation unit 12 further has a function of estimating the growth situation of the growing crop planted in the farm field for each of the plurality of division regions set in the farm field as described above. There are various methods for estimating the crop growth situation, and one of them is a method using an index called a normalized difference vegetation index (NDVI). The NDVI is one of indices for estimating a crop growth situation (vegetation situation) from a captured image of the crop using a feature of light reflection of the crop. The calculation expression for calculating the NDVI represented by the following Expression (1).

$$NDVI = ( NIR - R ) / ( NIR + R ) \qquad ( 1 )$$

where NIR in Expression (1) represents a reflectance in the near-infrared range acquired from the captured image, and R represents a reflectance in the visible red region acquired from the captured image. The NDVI can be said to be an index representing a growth situation of a leaf of a crop, and is represented within a range of a numerical value −1 to +1, and the closer the numerical value is to 1, the better the leaf growth.

The estimation unit 12 calculates the NDVI for each division region of the farm field from the captured image of the crop planted in the farm field, thereby estimating the growth situation of the growing crop for each division region in the farm field. The information indicating the crop growth situation in the farm field estimated in this manner is stored in the storage device 20 and the database 4 as growth situation distribution information. That is, in the first example embodiment, the growth situation distribution information is relational data between the position information about a division region and the value of the NDVI of the division region. The growth situation distribution information is associated with information about the imaging date and time of the captured image used for calculating the NDVI, weather information about the farm field at the imaging time point, and the like.

The growth period of the crop of which the estimation unit 12 estimates the growth situation is a period set by the farm field interested party or the like including at least the above-described fertilization information acquisition period of additional fertilizer. For example, the daily crop growth situation in the set period is estimated. Alternatively, the estimation frequency may be varied according to the growth period in such a way that the growth situation of the crop every four days is estimated in a period in which the crop is small, the growth situation of the crop every day is estimated in a period in which the leaf growth is remarkable, and the growth situation of the crop every five days is estimated in a period in which the leaf growth is settled.

In the first example embodiment, the estimation unit 12 uses a satellite image of the farm field for calculating the NDVI. In this case, the acquisition unit 11 acquires, from at least the information source 3, a satellite image captured during the fertilization information acquisition period related to basal fertilizer and the calculation period of the NDVI including the fertilization information acquisition period related to additional fertilizer.

The generation unit 13 generates basal fertilizer variable fertilization information. The basal fertilizer variable fertilization information is information indicating a relationship between a position in a farm field and the amount of applied fertilizer of basal fertilizer at the position in a case where variable fertilization of basal fertilizer is performed, and is used for variable fertilization of basal fertilizer. In the first example embodiment, base data to be used for generating basal fertilizer variable fertilization information is determined using the distribution information about the color of soil in the farm field and the following growth distribution record information. The growth distribution record information is information indicating the relationship between the region in the farm field and the actual (past) crop growth situation. The growth situation distribution information accumulated in the storage device 20 and the database 4 in the crop cultivation period (that is, the previous year, the year before the previous year, the year before the previous year, or the like) before the period in which variable fertilization of basal fertilizer using the basal fertilizer variable fertilization information generated by the generation unit 13 is performed is used as the growth distribution record information.

In the first example embodiment, the base data used for generating the basal fertilizer variable fertilization information is either the information about the estimation soil nitrogen distribution calculated by the estimation unit 12 or the growth distribution record information, and which is used is determined as follows. That is, the generation unit 13 determines, by correlation analysis or the like, whether there is a correlation between the color of soil in the farm field determined by the estimation unit 12 and the actual growth situation of the crop based on the growth distribution record information, for the farm field to be assisted. As a result of this determination, in a case where it is determined that there is a correlation between the color of soil and the growth situation, the generation unit 13 generates the basal fertilizer variable fertilization information using the information about the estimation soil nitrogen distribution. On the other hand, in a case where it is determined that there is no correlation between the color of soil and the growth situation, the generation unit 13 generates basal fertilizer variable fertilization information using the growth distribution record information. For example, the type of basal fertilizer to be applied to the farm field and the standard amount of applied fertilizer of basal fertilizer per unit area are determined in advance depending on the type of crops, soil quality of soil, and the like. With reference to the standard amount of applied fertilizer, the amount of applied fertilizer for each of the division regions in the farm field is determined in such a way as to eliminate unevenness of estimation soil nitrogen, or in such a way as to eliminate unevenness of the amount of soil nitrogen by regarding the distribution of the growth situation as unevenness of the amount of soil nitrogen, whereby the basal fertilizer variable fertilization information is generated.

In the first example embodiment, the reason why the base data to be used for generating the basal fertilizer variable fertilization information is determined as described above is as follows. That is, although variable fertilization of basal fertilizer is performed in such a way that the amount of soil nitrogen per unit area is the same over the entire farm field to suppress variations in the growth situation of the crops, there is a case where the growth situation of the crop planted in the farm field varies depending on the place. Such variations in the growth situation are considered to be related to variations in the fertility in which the fertility in the soil varies depending on the location. The fertility is productivity with which the soil grows crops. For example, various matters such as the biological properties of soil related to microorganisms and the like that change organic nitrogen of soil into ammonia nitrogen and nitrate nitrogen (inorganic nitrogen) that are easily taken into crops, the chemical properties of soil related to the hydrogen ion index, and physical properties such as air permeability and water retainability are involved in the fertility. For this reason, it is difficult to investigate the fertility itself, but it is considered that the variations in the fertility appear in variations in the growth situation of the crop. From this, in a case where there is a correlation between the distribution (in other words, the estimation soil nitrogen distribution) of the color of soil in the captured image imaged at the time of variable fertilization of basal fertilizer and the variations in the growth situation of the crop in the past, which is considered to be related to the variations in the fertility, it is considered that the color of soil represents not only the amount of soil nitrogen but also the fertility. For this reason, in the first example embodiment, in a case where it is determined that there is a correlation between the color of soil and the growth situation of the crop in the farm field, the generation unit 13 generates the basal fertilizer variable fertilization information using the information about the estimation soil nitrogen distribution. On the other hand, in a case where it is determined that there is no correlation between the color of soil and the growth situation of the crop in the farm field, the generation unit 13 generates the basal fertilizer variable fertilization information using the growth distribution record information in consideration of the fertility in order to suppress variations in the growth situation. The basal fertilizer variable fertilization information thus generated is stored in the storage device 20 and the database 4.

The generation unit 13 further has a function of generating additional fertilizer variable fertilization information using the growth situation distribution information. The additional fertilizer variable fertilization information is information indicating a relationship between a position in the farm field and the amount of applied fertilizer at the position in a case where the variable fertilization of additional fertilizer is performed. For example, the standard amount of applied fertilizer of additional fertilizer per unit area is determined in advance in consideration of the type of crops in the farm field, the climate in the region including the farm field, and the like. Using the standard amount of applied fertilizer of the additional fertilizer and the growth situation of the crop for each of the division regions in the farm field indicated in the growth situation distribution information, the amount of applied fertilizer of the additional fertilizer for each of the division regions in the farm field is calculated. Position information about a division region in the farm field is associated with the amount of applied fertilizer of additional fertilizer calculated for the division region, and additional fertilizer variable fertilization information is generated. The additional fertilizer variable fertilization information thus generated is stored in the storage device 20 and the database 4.

Upon receiving an information providing request for requesting the basal fertilizer variable fertilization information from the terminal device 5, the output unit 14 returns (outputs) the basal fertilizer variable fertilization information according to the request to the terminal device 5 as a request source. The terminal device 5 that has received the basal fertilizer variable fertilization information displays the basal fertilizer variable fertilization information on the display device by, for example, the display control function of the terminal device 5. That is, the output unit 14 outputs the basal fertilizer variable fertilization information in such a way as to display the information on the display device of the farm field interested party (user).

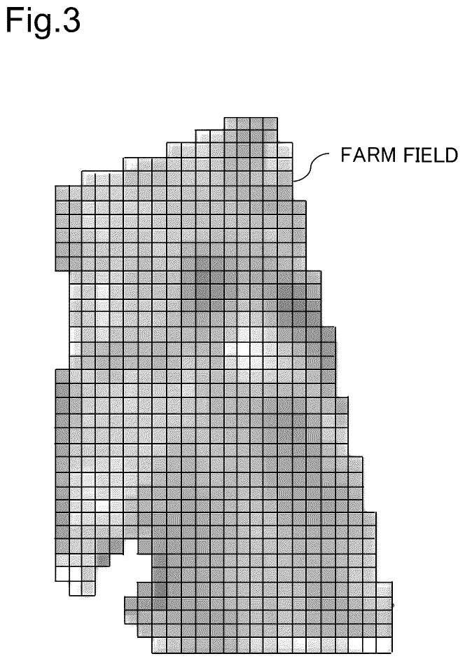

An example of the display mode of the basal fertilizer variable fertilization information includes, for example, a table mode in which the amount of applied fertilizer of basal fertilizer for each division region of the farm field is represented by a numerical value. Another example of the display mode of the basal fertilizer variable fertilization information includes a mode of a basal fertilizer variable fertilization map as illustrating in FIG. 3 in which the amount of applied fertilizer of basal fertilizer is represented by color coding for each division region in the image of the farm field. The display mode of the basal fertilizer variable fertilization information in the display device according to the terminal device 5 is a display mode set in advance by a device designer or the like, or selected from a plurality of display modes by a farm field interested party operating the terminal device 5.

The output of the additional fertilizer variable fertilization information by the output unit 14 is similar to the output of the basal fertilizer variable fertilization information, and when receiving an information providing request for requesting the output of the additional fertilizer variable fertilization information from the terminal device 5, the output unit 14 returns (outputs) the additional fertilizer variable fertilization information according to the request to the terminal device 5 as a request source. The terminal device 5 that has received the additional fertilizer variable fertilization information displays the additional fertilizer variable fertilization information on the display device by, for example, the display control function of the terminal device 5.

Furthermore, in a case where outputting the basal fertilizer variable fertilization information and the additional fertilizer variable fertilization information, the output unit 14 may output, to the terminal device 5, reference information related to variable fertilization, such as base data used to generate the basal fertilizer variable fertilization information and the additional fertilizer variable fertilization information, description of the basal fertilizer and the additional fertilizer, and information about the standard amount of applied fertilizer of the basal fertilizer and the additional fertilizer in the farm field. The terminal device 5 that has received such reference information displays the reference information side by side with the basal fertilizer variable fertilization information and the additional fertilizer variable fertilization information on the display device. Alternatively, the terminal device 5 may display the reference information on a screen different from the display screen of the basal fertilizer variable fertilization information and the additional fertilizer variable fertilization information.

In a case where the fertilization assistance apparatus 1 is directly connected to the variable fertilization control device 8, the output unit 14 outputs, to the variable fertilization control device 8, the basal fertilizer variable fertilization information and the additional fertilizer variable fertilization information related to a request in response to an information providing request from the variable fertilization control device 8. The basal fertilizer variable fertilization information and the additional fertilizer variable fertilization information may be output to the variable fertilization control device 8 via the terminal device 5.

The variable fertilization control device 8 controls the amount of applied fertilizer of basal fertilizer and additional fertilizer to be applied to the farm field based on position information about the agricultural machine 9 by a position sensor (for example, a position sensor using a global navigation satellite system (GNSS)) mounted on the agricultural machine 9 and the basal fertilizer variable fertilization information or the additional fertilizer variable fertilization information.

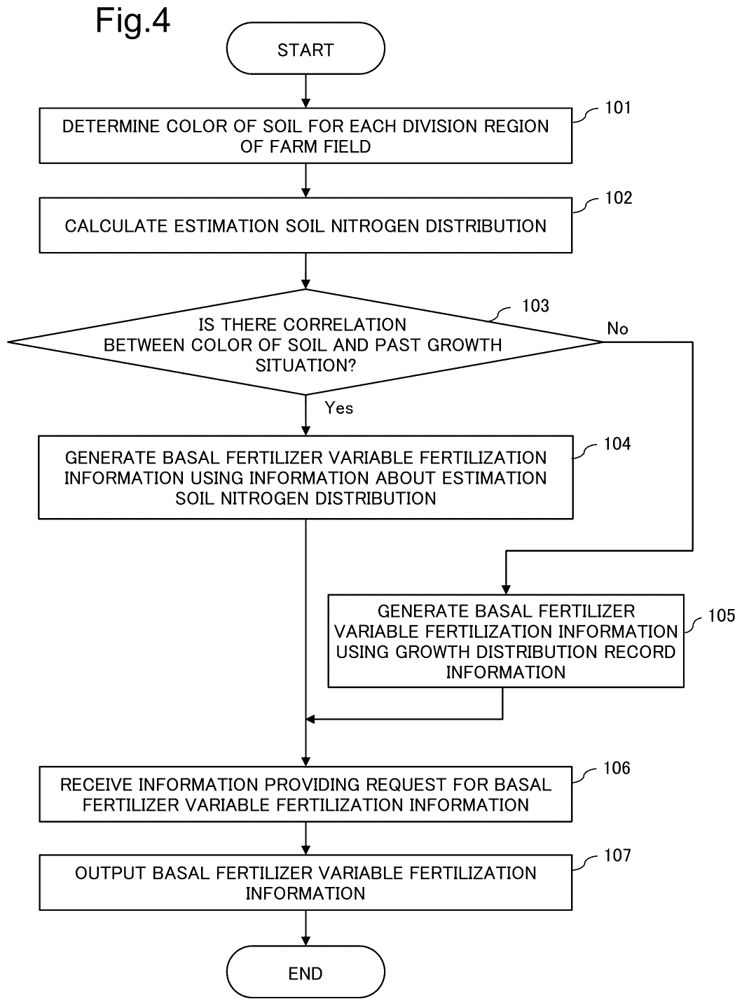

The fertilization assistance apparatus 1 of the first example embodiment is configured as described above. Next, an example of an operation related to generation to output of basal fertilizer variable fertilization information in the fertilization assistance apparatus 1 will be described with reference to FIG. 4. FIG. 4 is a flowchart illustrating an example of an operation related to generation and output of basal fertilizer variable fertilization information in the fertilization assistance apparatus 1.

For example, in a state in which the satellite image of the farm field in the fertilization information acquisition period related to basal fertilizer has been acquired by the acquisition unit 11, the estimation unit 12 determines the color of soil of the farm field in the satellite image for each of the division regions (step 101 in FIG. 4). Then, the estimation unit 12 calculates an estimation soil nitrogen distribution in the farm field using the determination result (step 102). After that, the generation unit 13 determines whether there is a correlation between the color of soil of the farm field determined by the estimation unit 12 and the growth situation of the farm field based on the growth distribution record information by correlation analysis (step 103). As a result, in a case where it is determined that there is a correlation between the color of soil of the farm field and the growth situation, the generation unit 13 generates the basal fertilizer variable fertilization information using the estimation soil nitrogen distribution calculated by the estimation unit 12 (step 104). In a case where it is determined that there is no correlation between the color of soil of the farm field and the growth situation, the generation unit 13 generates the basal fertilizer variable fertilization information using the growth distribution record information (step 105). The basal fertilizer variable fertilization information thus generated is stored in the storage device 20 and the database 4.

Thereafter, for example, when the fertilization assistance apparatus 1 receives an information providing request for the basal fertilizer variable fertilization information output from the terminal device 5 (step 106), the output unit 14 outputs the basal fertilizer variable fertilization information related to the request to the terminal device 5 as a request source (step 107). The terminal device 5 displays the received basal fertilizer variable fertilization information on a display device. In a case where the basal fertilizer variable fertilization information is further output (transmitted) from the terminal device 5 to the variable fertilization control device 8 of the agricultural machine 9, the variable fertilization control device 8 controls the amount of applied fertilizer of basal fertilizer to be applied to the farm field using the basal fertilizer variable fertilization information and the position information about the agricultural machine 9, whereby the variable fertilization of basal fertilizer is performed.

As described above, the fertilization assistance apparatus 1 of the first example embodiment generates the basal fertilizer variable fertilization information using the information about the estimation soil nitrogen distribution in a case where there is a correlation between the color of soil and the growth situation of the crop in the farm field, and generates the basal fertilizer variable fertilization information using the growth distribution record information in a case where there is no correlation. In other words, in a case where it is assumed that the information about the estimation soil nitrogen distribution represents not only the distribution of the amount of soil nitrogen but also the distribution of the fertility in the farm field, the basal fertilizer variable fertilization information is generated using the information about the estimation soil nitrogen distribution. In a case where it is assumed that the distribution of the amount of soil nitrogen is different from the distribution of fertility in the farm field, the basal fertilizer variable fertilization information is generated using the growth distribution record information considered to be close to the distribution of fertility. That is, the fertilization assistance apparatus 1 of the first example embodiment has a configuration to generate the basal fertilizer variable fertilization information in consideration of not only the amount of soil nitrogen but also the fertility that affects the crop growth situation in the farm field. By performing variable fertilization of basal fertilizer in a farm field using the basal fertilizer variable fertilization information generated by the fertilization assistance apparatus 1, variable fertilization of basal fertilizer in consideration of fertility in the farm field is performed, so that it is expected that variations in the growth situation of crops are suppressed. That is, the fertilization assistance apparatus 1 can propose information about the amount of applied fertilizer of the variable fertilization of basal fertilizer in order to suppress the variations in the growth situation of the crop in the farm field. As a result, the fertilization assistance apparatus 1 can also exhibit the following effects. That is, since the variable fertilization of basal fertilizer based on the fertilization map disclosed in JP 2011-254711 A or the like is performed in the farm field, a farm field interested party may suspect that the variations in the growth situation of the crop in the farm field is larger than that in the case where the variable fertilization is not performed. For this reason, among the farm field interested parties, there are some farm field interested parties who cannot go with variable fertilization of basal fertilizer due to a concern that the variations in the growth situation of crops may be large. On the other hand, since the fertilization assistance apparatus 1 can provide the basal fertilizer variable fertilization information capable of solving such a concern, it is possible to increase the number of the farm field interested parties who perform the variable fertilization of basal fertilizer.

### Second Example Embodiment

Hereinafter, the second example embodiment according to the present disclosure will be described. In the description of the second example embodiment, components having the same names as those used in the description of the fertilization assistance apparatus of the first example embodiment are denoted by the same reference numerals, and redundant description thereof will be omitted.

In the fertilization assistance apparatus 1 of the second example embodiment, the following circumstances are considered. That is, some crops are in a growth stage where the leaves of the crops are small and the number of leaves is small in the time of providing additional fertilizer. In such a case, there is a case where the value of the NDVI obtained from the satellite image cannot represent the growth situation (that is, the growth situation of the crop) of the leaf of the crop because the reflection of light caused by the leaf of the crop in the farm field is small. The fertilization assistance apparatus 1 of the second example embodiment has a configuration (function) in consideration of such circumstances. That is, in the second example embodiment, the generation unit 13 determines the base data to be used for generating the additional fertilizer variable fertilization information using the color of the farm field (crop) of the satellite image in the period in which the variable fertilization of additional fertilizer is performed and the presence or absence of the correlation between the color of soil and the growth situation of the crop in the farm field as described in the description of the first example embodiment.

That is, the generation unit 13 detects the color of the image of the crop from the satellite image of the farm field in the period in which the variable fertilization of additional fertilizer is performed, and determines whether the intensity of green (green light) in the image of the crop is equal to or more than a threshold value set in advance. The threshold value is a value for determining whether the value of the NDVI is a leaf growth situation that can appropriately represent the growth situation of the leaf of the crop using the green color of the image of the crop. This threshold value is set in advance by, for example, analysis of a relationship between a color of a crop in a satellite image, a value of the NDVI in the crop, and a growth situation of the crop.

In a case where the color of the image of the crop in the satellite image at the time of performing the variable fertilization of additional fertilizer is equal to or more than the threshold value, the generation unit 13 determines that the image of the crop in the satellite image satisfies a predetermined growth detection condition. That is, in the second example embodiment, the growth detection condition is a condition for a leaf growth situation in which the value of the NDVI according to the growth situation of the crop can be calculated from the satellite image, and is a condition that the intensity of green in the image of the crop is equal to or more than the threshold value.

In a case where the image of the crop in the satellite image satisfies the growth detection condition, the generation unit 13 calculates in-growth growth distribution information from the satellite image, and generates the additional fertilizer variable fertilization information using the calculated in-growth growth distribution information.

In a case where it is determined that the image of the crop in the satellite image does not satisfy the growth detection condition, and there is a correlation between the color of soil and the growth situation of the crop in the farm field in generating the basal fertilizer variable fertilization information, the generation unit 13 generates the additional fertilizer variable fertilization information using the estimation soil nitrogen distribution.

Furthermore, in a case where it is determined that the image of the crop in the satellite image does not satisfy the growth detection condition and there is no correlation between the color of soil and the growth situation of the crop in the farm field, the generation unit 13 generates the additional fertilizer variable fertilization information using the growth distribution record information about the crop in the farm field in the past.

The configuration of the fertilization assistance apparatus 1 of the second example embodiment other than the above-described configuration is similar to that of the fertilization assistance apparatus 1 of the first example embodiment.

Since the fertilization assistance apparatus 1 of the second example embodiment has a similar configuration to the fertilization assistance apparatus 1 of the first example embodiment, it is possible to achieve the same effect as the fertilization assistance apparatus 1 of the first example embodiment. Furthermore, in the fertilization assistance apparatus 1 of the second example embodiment, since the generation unit 13 has the above-described configuration regarding the generation of the additional fertilizer variable fertilization information, the following effects can be obtained. That is, in a case where the value of the NDVI calculated from the satellite image at the time of variable fertilization of additional fertilizer cannot represent the leaf growth situation (that is, the growth situation of the crop) of the crop, the fertilization assistance apparatus 1 generates the additional fertilizer variable fertilization information using the information about the estimation soil nitrogen distribution and the crop growth distribution record information that can estimate the variations in the growth situation of the crop, instead of the in-growth growth distribution information. As a result, the fertilization assistance apparatus 1 of the second example embodiment can generate the additional fertilizer variable fertilization information effective for suppressing variations in the growth situation of the crop even in a case where the value of the NDVI cannot represent the growth situation of the leaf of the crop (the growth situation of the crop).

### Third Example Embodiment

Hereinafter, the third example embodiment according to the present disclosure will be described. In the description of the third example embodiment, components having the same names as those used in the description of the fertilization assistance apparatus of the first and second example embodiments are denoted by the same reference numerals, and redundant description thereof will be omitted.

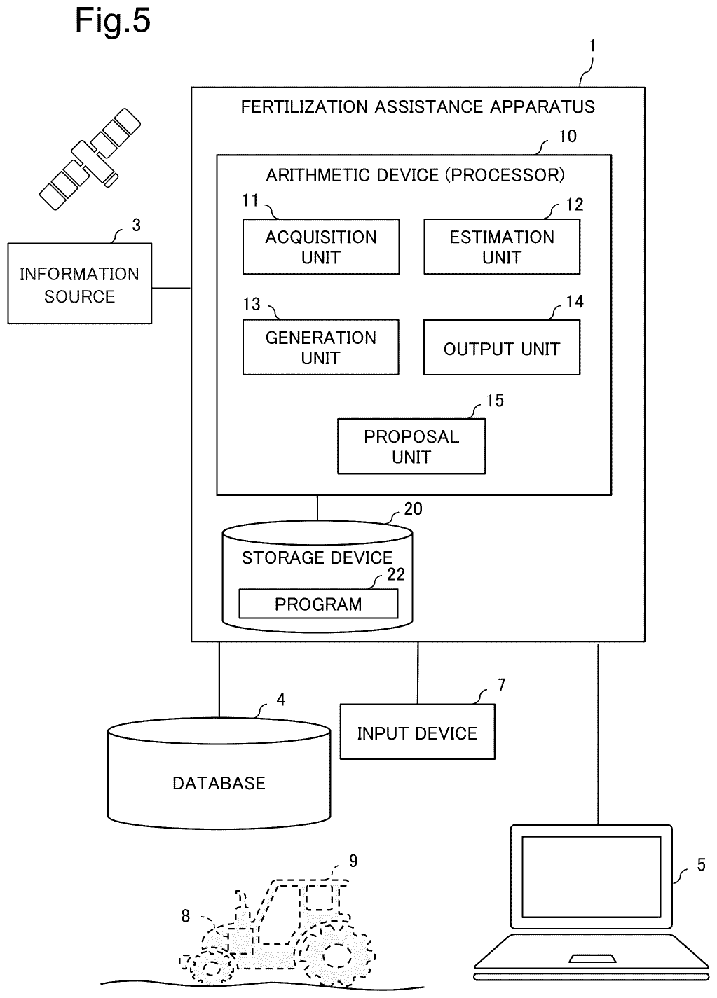

The fertilization assistance apparatus 1 of the third example embodiment includes a proposal unit 15 illustrated in FIG. 5 in addition to the configuration of the first or second example embodiment. The proposal unit 15 proposes an improvement idea for improving the soil of the farm field using the estimation soil nitrogen distribution. That is, soil improvement necessity determination information and improvement proposal information are given in advance to the fertilization assistance apparatus 1. The soil improvement necessity determination information is information serving as a criterion for determining whether it is necessary to improve the soil of the farm field using the estimation soil nitrogen distribution. The improvement proposal information is information in which an estimation soil nitrogen distribution of a farm field requiring improvement is associated with an improvement idea for improving the soil of the farm field.

The proposal unit 15 determines whether it is necessary to improve the soil of the farm field to be assisted using the estimation soil nitrogen distribution in the farm field and the soil improvement necessity determination information. In a case where it is necessary to improve the soil, the proposal unit 15 outputs an improvement idea extracted from the improvement proposal information using the estimation soil nitrogen distribution to the terminal device 5 related to the farm field to be assisted via the output unit 14.

The above-described soil improvement necessity determination by the proposal unit 15 is executed at a predetermined timing. As a result of the soil improvement necessity determination, in a case where it is not necessary to take measures to improve the soil, the proposal unit 15 enters a standby state in preparation for the next soil improvement necessity determination.

Since the fertilization assistance apparatus 1 of the third example embodiment has the same configuration as the fertilization assistance apparatus 1 of the first example embodiment, it is possible to achieve the same effect as the fertilization assistance apparatus 1 of the first example embodiment. Furthermore, since the fertilization assistance apparatus 1 of the third example embodiment further includes the proposal unit 15 as described above, it is possible to enhance the convenience for the farm field interested party.

### Other Example Embodiments

The present disclosure is not limited to the first to third example embodiments, and various example embodiments can be used. For example, in the first to third example embodiments, the size of the division region in the farm field is a predetermined fixed value. Alternatively, for example, the fertilization assistance apparatus 1 may have a function of receiving a request for changing the size of the division region in the farm field from the terminal device 5, and the generation unit 13 may generate the basal fertilizer variable fertilization information and the additional fertilizer variable fertilization information by calculating the amount of applied fertilizer for the division region having the size according to the change request.

The fertilization assistance apparatus 1 may further have a function of comparing the distribution of the amount of applied fertilizer of basal fertilizer that can be acquired from the basal fertilizer variable fertilization information with the actual growth situation of the crop in the farm field, and in a case where there is a division region that is in a growth situation in which the deviation from the expected growth situation is bad beyond the permissible range despite the variable fertilization of basal fertilizer, notifying the farm field interested party of the situation of the division region. Furthermore, the fertilization assistance apparatus 1 may have a function of notifying a farm field interested party of recommended measures for the division region in which the growth situation is not preferable.

Furthermore, in the first to third example embodiments, a satellite image is used as a captured image of the farm field. Alternatively, an image of the farm field captured by an imaging device mounted on an unmanned aerial vehicle such as a helicopter or a drone may be used as the captured image of the farm field.

Furthermore, in an example of the operation in the fertilization assistance apparatus 1 described in the first example embodiment, as illustrated in FIG. 4, the estimation soil nitrogen distribution is calculated before determining whether there is a correlation between the color of soil and the past growth situation. Alternatively, in a case where the estimation soil nitrogen distribution is not used other than when the basal fertilizer variable fertilization information is generated, it is determined whether there is a correlation between the color of soil and the past growth situation, and in a case where it is determined that there is a correlation, the estimation soil nitrogen distribution may be calculated.

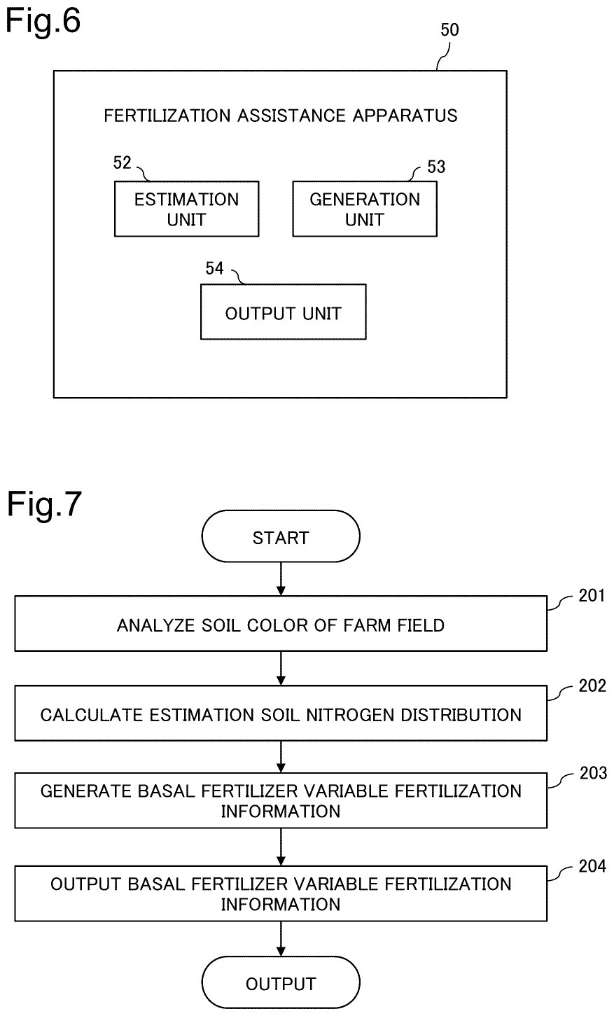

Next, a configuration of a fertilization assistance apparatus according to another example embodiment of the present disclosure will be described. A fertilization assistance apparatus 50 of another example embodiment is, for example, a computer device having a configuration as illustrated in FIG. 6, and includes an estimation unit 52, a generation unit 53, and an output unit 54 as functional units implemented by executing a computer program given to the computer device.

The estimation unit 52 estimates the distribution of the amount of soil nitrogen in the farm field as the estimation soil nitrogen distribution by analyzing the color of soil of the farm field in the captured image in which the farm field before planting is imaged.

The generation unit 53 determines whether there is a correlation between the color of soil and the growth situation of the crop in the farm field using the growth distribution record information and the distribution information about the color of soil. The growth distribution record information is information indicating the relationship between the region in the farm field and the growth situation of the crop in the crop cultivation period before the imaging time point of the captured image used for estimating the distribution of the amount of soil nitrogen.

In a case where there is a correlation between the color of soil and the growth situation of the crop in the farm field, the generation unit 53 generates basal fertilizer variable fertilization information indicating a relationship between the position in the farm field and the amount of applied fertilizer at the position in a case where the variable fertilization of basal fertilizer is performed, using the information about the estimation soil nitrogen distribution.

The output unit 54 outputs basal fertilizer variable fertilization information.

Next, an example of an operation of the fertilization assistance apparatus 50 will be described with reference to FIG. 7. FIG. 7 is a flowchart illustrating an example of an operation of the fertilization assistance apparatus 50.

For example, the estimation unit 52 first analyzes the color of soil of the farm field in the captured image in which the farm field before planting is imaged (step 201). Then, the estimation unit 52 calculates the distribution of the amount of soil nitrogen of the farm field as the estimation soil nitrogen distribution using the analysis result (step 202). Thereafter, the generation unit 53 determines whether there is a correlation between the color of soil and the growth situation of the crop in the farm field using the growth distribution record information and the distribution information about the color of soil. Furthermore, in a case where there is a correlation between the color of soil and the growth situation of the crop in the farm field, the generation unit 53 generates the basal fertilizer variable fertilization information using the information about the estimation soil nitrogen distribution (step 203). After that, the output unit 54 outputs the basal fertilizer variable fertilization information (step 204).

Since the fertilization assistance apparatus 50 has the above-described configuration, the basal fertilizer variable fertilization information is generated using the information about the estimation soil nitrogen distribution assumed to represent the information about the fertility of the soil in the farm field. That is, the fertilization assistance apparatus 50 can propose information about the amount of applied fertilizer of the variable fertilization of basal fertilizer in order to suppress variations in the growth situation of the crop in the farm field.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A fertilization assistance apparatus comprising:
a memory configured to store instructions; and
a processor configured to execute the instructions to:
estimate a distribution of an amount of soil nitrogen in a farm field as an estimation soil nitrogen distribution by analyzing a color of soil in the farm field in a captured image in which the farm field before planting is imaged;
generate basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and
output the basal fertilizer variable fertilization information.

2. The fertilization assistance apparatus according to claim 1, wherein the processor is configured to execute the instructions to:
in a case where it is determined that there is no correlation between a color of soil in the farm field and a growth situation of a crop, generate the basal fertilizer variable fertilization information using the growth distribution record information.

3. The fertilization assistance apparatus according to claim 1, wherein the processor is further configured to execute the instructions to:
generate additional fertilizer variable fertilization information using growth situation distribution information, the additional fertilizer variable fertilization information indicating a relationship between a position in the farm field and an amount of applied fertilizer at the position in a case where variable fertilization of additional fertilizer is performed, the growth situation distribution information indicating a distribution of a growth situation of a crop in the farm field calculated using a captured image in which a growing crop in the farm field is imaged.

4. The fertilization assistance apparatus according to claim 3, wherein the processor further is configured to execute the instructions to:
determine whether an image of a crop in a captured image in which the crop of the farm field is imaged in a period in which variable fertilization of additional fertilizer is performed satisfies a predetermined growth detection condition,
in a case where the image of the crop in the captured image satisfies the growth detection condition, calculate in-growth growth distribution information from the captured image and generate additional fertilizer variable fertilization information using the calculated in-growth growth distribution information,
in a case where the image of the crop in the captured image does not satisfy the growth detection condition and it is determined that there is a correlation between a color of soil in the farm field and a growth situation of a crop, generate additional fertilizer variable fertilization information using an estimation soil nitrogen distribution, and
in a case where the image of the crop in the captured image does not satisfy the growth detection condition and it is determined that there is no correlation between a color of soil in the farm field and a growth situation of a crop, generate additional fertilizer variable fertilization information using growth distribution record information.

5. The fertilization assistance apparatus according to claim 1, wherein the processor is configured to execute the instructions to:
output the basal fertilizer variable fertilization information to be displayed on a display device of the user.

6. The fertilization assistance apparatus according to claim 1, wherein the processor is further configured to execute the instructions to:
generate an improvement idea for improving soil in the farm field using the estimation soil nitrogen distribution.

7. A fertilization assistance method executed by a computer, the method comprising:
estimating a distribution of an amount of soil nitrogen in a farm field as an estimation soil nitrogen distribution by analyzing a color of soil in the farm field in a captured image in which the farm field before planting is imaged;
generating basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and
outputting the basal fertilizer variable fertilization information.

8. A non-transitory computer readable medium that stores a computer program, the computer program causing a computer to execute the steps of:
estimating a distribution of an amount of soil nitrogen in a farm field as an estimation soil nitrogen distribution by analyzing a color of soil in the farm field in a captured image in which the farm field before planting is imaged;
generating basal fertilizer variable fertilization information using information about the estimation soil nitrogen distribution in a case where it is determined that there is a correlation between a color of soil in the farm field and a growth situation of a crop using growth distribution record information and distribution information about the color of soil, the basal fertilizer variable fertilization information indicating a relationship between a position in the farm field and an amount of applied fertilizer at the position in a case where variable fertilization of basal fertilizer is performed, the growth distribution record information indicating a relationship between a region in the farm field and the growth situation of the crop in a crop cultivation period before an imaging time point of the captured image used for estimating the distribution of the amount of soil nitrogen and distribution information about the color of soil; and
outputting the basal fertilizer variable fertilization information.
